(19) United States
(12) Patent Application Publication
(10) Pub. No.: US 2006/0188860 A1
(43) Pub. Date: Aug. 24, 2006

(54) On-task learning system and method

(75) Inventor: Andrew S. Morrison, Deerfield, IL (US)

Correspondence Address: DLA PIPER RUDNICK GRAY CARY US, LLP, 2000 UNIVERSITY AVENUE, E. PALO ALTO, CA, 94303-2248, US

(73) Assignee: Altis Avante, Inc.

(21) Appl. No.: 11/347,425

(22) Filed: Feb. 2, 2006

Related U.S. Application Data
(60) Provisional application No. 60/656,058, filed on Feb. 24, 2005.

(51) Int. Cl. G09B 3/00; G09B 7/00

(52) U.S. Cl. 434/322; 434/219; 434/362

(57) ABSTRACT

The on-task learning system (implemented as a training system and method) achieves the goal to keeping a student on a learning task for a longer period of time by providing a customized education program for each student. In one implementation, the training system uses one or more portable devices and a main training unit so that the student may utilize the portable device away from school to perform directed learning and stay on the learning task even while away from school.

### RELATED APPLICATION/PRIORITY CLAIM

This application claims priority under 35 USC 119(e) to U.S. Provisional Patent Application Ser. No. 60/656,058 filed on Feb. 24, 2005 and entitled “Educational Mass Customization System and Method”, the entirety of which is incorporated herein by reference.

### FIELD OF THE INVENTION

The invention relates generally to an on-task learning system and method and in particular to a computer-implemented, on-task learning system and method that incorporates an automated educational mass customization system and method and an autonomous synchronization system and method.

### BACKGROUND OF THE INVENTION

Research demonstrates that one of the most impactful ways to improve student learning is to increase the student's time-on-task. Increasing “time-on-task” is comprised of two components: (i) increasing the amount of time that a student is engaged in a task; and (ii) ensuring that the student is working on a task having the proper instruction. The “proper instruction” for the student means that the student receives the appropriate pedagogy and that the instruction is delivered at the appropriate rate and level for the particular student. It is desirable to provide a system that helps ensure that the student increases the amount of time devoted to learning, and that this effort is spent “on task”, that is, among other things, receiving the proper instruction, pedagogically and at the appropriate rate and level. Thus, the invention is directed to a system and method that increases the “time-on-task” of each student.

### SUMMARY OF THE INVENTION

An on-task learning system and method are provided. The system increases a student's time-on-task which is a powerful way to improve student learning. The system helps ensure that the student increases the amount of time/effort devoted to learning, and that the effort is spent “on task”, that is, among other things, receiving the proper instruction, pedagogically and at the appropriate rate and level.

The system uses several strategies to increase the amount of time that a student spends learning. Two of these strategies are to increase student interest/engagement and to extend instruction into times of the day that are not typically used for learning. In order to help students, especially students with a history of academic struggle, to increase the amount of time that they dedicate to receiving instruction, it is important that the instruction engage each student's interest and reach him or her on a personal level. Additionally, as there often is not enough time available in the typical school day for some students to spend as much time as is necessary or desirable on a particular subject, methods for extending learning outside of the designated classroom time are desirable. The system may provide educational mass customization as described below and an autonomous synchronization platform as described below that help enhance student interest and engagement and extend learning into additional times and places in the student's day.

The system also ensures that, in addition to increasing a student's study/learning time, that the student spends that learning time “on task.” Hence, the invention, in an automated fashion, ensures that the student is always working on pedagogically sound instruction, at the appropriate rate and level, as individually determined on a case-by-case basis for each student. The “on-task” determination of the system provides periodic assessment of the student's abilities as well as the automated, on-going assessment of each student and the constant adjustment of numerous learning variables to always maintain each student's level of engagement and ensure that the time is spent “on task.” The educational mass customization aspects of the invention (in addition to the engagement factors) also advance the on-task factors of the student experience. The system permits the aforementioned benefits to be achieved with minimal or no adverse impact on instructor time, classroom organization, the needs of fellow students, etc. In fact, the system may enhance the learning environment and outcomes of students while creating savings and synergies for schools, teachers, parents, and others, in time, management, cost and the like.

The on-task system and method may include an educational mass customization system and method and an autonomous synchronization system and method. The educational mass customization system and method is one of the aspects of the on-task system that achieves the goal of increasing a student's time-on-task. The educational mass customization delivers an education program that is customized to each student, as appropriate. The customization is both deep and broad, so that it not only adjusts and individualizes instruction according to the particular needs of the student, but will also customize according to other aspects/factors associated with each student. The educational program may be customized based on various factors (known as educational customization factors.) In a preferred embodiment, the customization of the program may be performed automatically by an educational mass customization engine that is part of the on-task system. Thus, each student is provided with an educational program that is uniquely customized to that particular student, not only with respect to his or her needs and abilities, but also to his or her background, expressed interests, language, culture, history, life experiences and other variables designed to be relevant to the student, engage the student's interests, and increase the amount of time the student spends learning.

In this manner, the system provides customized educational programs for each individual student so that each student is more interested, more engaged, and more likely to increase his or her time-on-task. In addition, as mentioned above, educational mass customization ensures that each student is working on pedagogically sound, pedagogically appropriate content, at the right level and the right rate, for that individual student. In other words, the educational program is massively customized—massively by customizing so many instructional aspects of the program, massively by customizing the program for each individual student, massively by customizing along a deep and broad set of individual variables for each student and/or massively by applying the variables and instructional aspect of the program across large groups of students wherein the instruction is customized to each student that is part of the large group. The system may also provide for the adaptive evolution of the characters in the educational program so that, unlike other educational programs, the characters evolve, change, grow and adapt depending on certain variables, such as the amount of instruction mastered by the student, the nature of the instructional/pedagogical challenge the program is then presenting to the student, the length of student play, or other customized/individualized aspects of the student or the student's behaviors on the program.

The on-task training system and method also provides the autonomous synchronization platform that increases the amount of time spent in learning. The autonomous synchronization ensures that the training of the student and the learning done by the student (the results of the training) are always synchronized between the student device and a main training device. In one exemplary embodiment, the student device is a portable device on which the student may receive training and instructions and the main training device may be a central training computer system located at a school wherein the portable devices of the students and the central training computer system are coupled to each other by a network.

### BRIEF DESCRIPTION OF THE DRAWINGS

FIG. 1 is a diagram illustrating an implementation of a computer-based on-task learning system that includes an autonomous synchronization platform;

FIG. 2 is a diagram illustrating an example of the portable device shown in FIG. 1;

FIG. 3 is a diagram illustrating an example of the main training unit shown in FIG. 1; and

FIG. 4 is a flowchart illustrating a method for educational training in accordance with the invention.

### DETAILED DESCRIPTION OF A PREFERRED EMBODIMENT

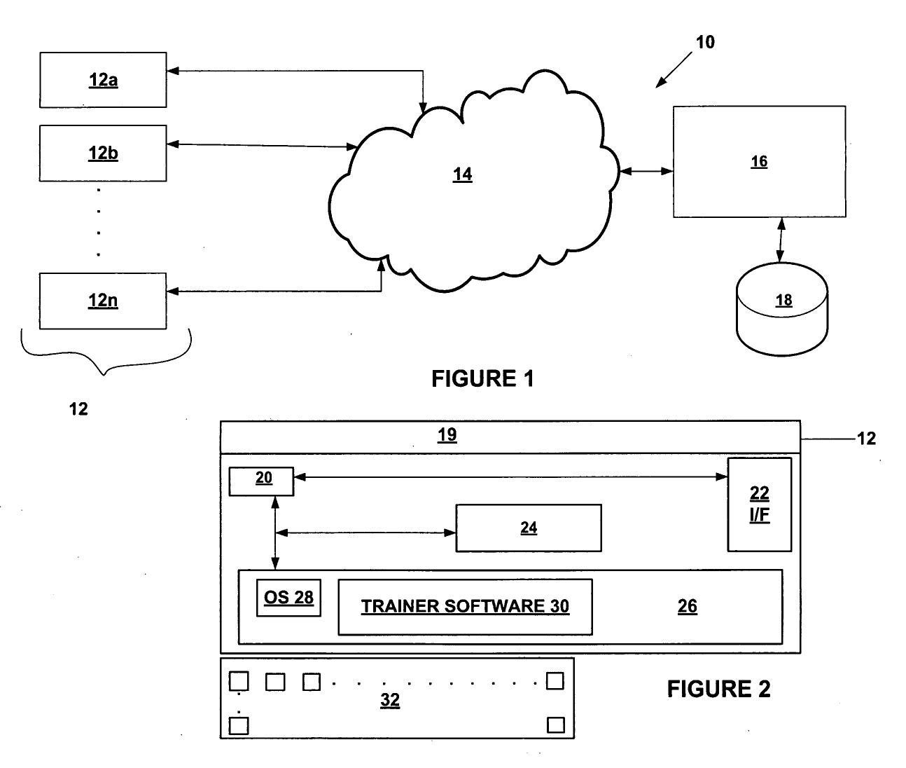

The present invention is particularly applicable as web-based educational training system and method for elementary school, middle school and high school students, but it may also be deployed for a variety of other individuals, such as illiterate and mentally disabled people, individuals whose native language is not English (including non-native English speakers who are learning to read), and adolescents and adults who read poorly and wish to improve their reading skills. For purposes of this document, all of the individuals listed above are students who can use the on-task training system and method in accordance with the invention. Moreover, it will be appreciated, that the system and method in accordance with the invention has greater utility since it may be used to increase the skills of a student in a variety of different non-educational skill areas, such as a particular trade or craft. Thus, the invention is not limited to any particular type of training or learning and is applicable to any type of learning or training. An on-task system and method in accordance with the invention includes an educational mass customization system (described in more detail below with reference to FIG. 2-4) and an autonomous synchronization platform which will now be described in more detail. The invention may also be implemented using various different computer architectures and networks and is not limited to the Internet-based model shown in FIG. 1.

FIG. 1 is a diagram illustrating an implementation of a computer-based on-task learning system 10 that includes an autonomous synchronization platform. The system 10 may comprise one or more portable devices 12, such as portable devices 12a, 12b and 12n as shown in FIG. 1, that are capable of communicating over a communications path 14 to a main training unit 16 that has a data store 18 associated with it.

An implementation of the autonomous synchronization platform is an educational training system that may be implemented in a variety of different computer architectures such as a desktop model in which the functionality of the main training unit and the portable device are both resident on a single computer, a local area network model in which the main training unit and portable devices communication over a local area network, a wide area network model in which the main training unit and portable devices communication over a wide area network, an application service provider (ASP) model in which the training module is executed on the main training unit with the user interfaces being communicated to the portable devices, or any other type of computer network/system. For purposes of this discussion, the local area network model will be described.

In a preferred implementation of the autonomous synchronization platform, the on-task learning system uses a local area network and the Internet and may be used to train reading/language skills of elementary, middle school and high school students and it is in this context that the invention is described although the invention may be used to train various skills. In this exemplary implementation of the educational training system, the system may have a main training unit 16, which may be a computer system, and one or more portable devices 12 that together implement the autonomous synchronization functions. In this system, it is intended that the portable devices are provided to students and are operated away from the school, such as at home, so that the students continue learning skills at home outside of the school. However, the system also permits the same individualized time-on-task learning to occur at school so that the time-on-task learning at school and on the portable device is coordinated.

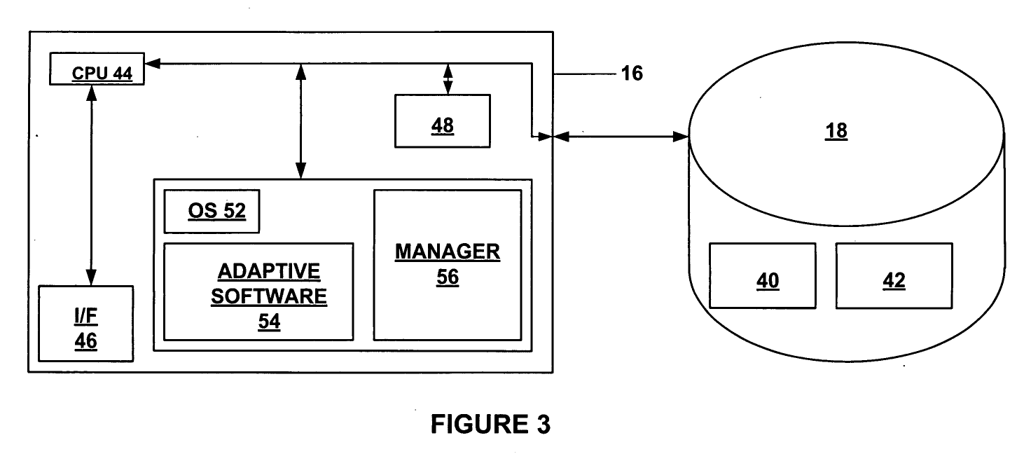

Returning to FIG. 1, each portable device may be a computer-based system with sufficient computing power and memory to store and execute a training module (that is part of the customized educational program of the student or otherwise) that is interacted with by a student using the portable device and with sufficient connectivity to communicate with the main training unit. Each portable device may be, for example, a laptop computer, tablet computer, handheld computer, pocket PC, PDA, wireless email device, mobile phone and the like. In a preferred implementation of the system, the portable device is a limited function computing device, such as the commercially available Nova 5000 device made by Fourier Systems, Inc. (See http://www.fourier-sys.com). In a preferred embodiment, the main training unit 16 may be one or more server computers. In a preferred embodiment of the invention, the portable devices communicate with the main training unit over a wireless network, but may also communicate over any other known communications path such as a cellular network, wired computer network such as a local area network or a wide area network or a wireless computer network so that the invention is not limited to any particular type of communications path. The details of each portable device and the main training unit are described below with reference to FIGS. 2 and 3.

In accordance with the invention, a customized educational program for a particular student is one or more training modules/games/assignments (preferably stored in the data store 18) selected by the main training unit 16 for the student based on a set of educational customization factors. The educational customization factors may include, but are not limited to, the student's score on prior educational programs or modules, the time it took the student to complete a particular portion of the educational program, learning preference of the student such as the types of training or the times during which training occurs (for example, a student might do very poorly on Monday so that the system customizes the educational program for that student so that Monday is a review day), the age of the student, the native language of the student, the race of the student, the gender of the student, the geographic location of the student, the hobbies and interests of that student and many other factors and information that are associated with each student, and may be used to customize an educational program. In general, the factors are used to provide a customized educational program that is uniquely tailored to each particular student, and the invention is not limited to any particular set of factors, and encompasses any factor or piece of information associated with that student.

In a preferred embodiment, the customization of the program may be performed automatically by an educational mass customization engine that is part of a manager unit 56 shown in FIG. 3 of the main training unit 16. Thus, each student is provided with an educational program that is uniquely customized to that particular student, not only with respect to his or her needs and abilities, but also to his or her background, expressed interests, language, culture, history, life experiences, gaming preferences and other variables designed to be relevant to the student, engage the student's interests, and increase the amount of time the student spends learning. The gaming preferences may include information about how the particular student best learns information—learning style preferences of the student (auditory instruction, visual instruction or interactive instruction for example) so that the instruction presented to each student in more likely to be learned when delivered according to the learning style preferences of the student.

Any educational mass customization factor may be activated (used to customize the educational program) or de-activated (not used to customize the educational program) by the instructor for each student (or automatically by the system using some programmed logic) so that each student may have a different set of activated educational customization factors. The educational mass customization system, based on the currently activated educational customization factors for each student (e.g., race, age, grade level, gender, geographic location, etc,), may also adjust the game play (that is part of the customized educational program) for factors such as the student's interests, interest level, role models, gender, story lines, etc. Thus, for example, a ten year old African American boy who lives in Florida may be very interested in baseball and surfing. Using the educational mass customization system, not only will his instructional levels adjust based on his current skill levels and performance, but the characters in his games/training (that are part of his customized educational program) could automatically adjust to reflect a greater percentage of male characters and characters who are African American themselves so that the student relates more closely to the characters, becomes more engaged in the program, and is more likely to spend more time-on-task. Moreover, because of his interest in baseball, the customized education program content for non-fiction reading exercises may discuss the legacy of Jackie Robinson and his struggle with race issues and his breaking the baseball color barrier. Moreover, the educational mass customization system might also present African American role models who surf. In addition, any follow-up research and activities assigned to the student by the educational mass customization system could relate to these themes, customized and presented according to the information about the student and the interests of the student.

In this manner, the system provides customized educational programs for each individual student so that each student is more interested, more engaged, and more likely to increase his or her time-on-task. In addition, as mentioned above, educational mass customization ensures that each student is working on pedagogically sound, pedagogically appropriate content, at the right level and the right rate, for that individual student. In other words, the educational program is massively customized-massively by customizing so many instructional aspects of the program, massively by customizing the program for each individual student, massively by customizing along a deep and broad set of individual variables for each student and/or massively by applying the variables and instructional aspect of the program across large groups of students wherein the instruction is customized to each student that is part of the large group. The system may also provide for the adaptive evolution of the characters in the educational program so that, unlike other educational programs, the characters evolve, change, grow and adapt depending on certain variables, such as the amount of instruction mastered by the student, the nature of the instructional/pedagogical challenge the program is then presenting to the student, the length of student play, or other customized/individualized aspects of the student or the student's behaviors on the program.

Another aspect of the invention is the adaptive evolution of the characters in the educational program. Unlike other educational programs, this invention contains characters who evolve, change, grow and adapt depending on certain variables, such as the amount of instruction mastered by the student, the nature of the instructional/pedagogical challenge the program is then presenting to the student, the length of student play, or other customized/individualized aspects of the student or the student's behaviors on the program (as discussed above). The nature of the character evolution could be behavioral (e.g., develops a sense of humor), could be skills or ability-based (e.g., becomes wiser; learns the skills that the student just mastered; becomes stronger or faster) or has access to more resources (e.g., various tools become available, has currency available in various amounts, has friends/advisors to consult with, etc.).

The system 10 may have a plurality of training modules (preferably stored in the data store 18) wherein each training module delivered to a portable device and executed by each portable device may train a particular reading skill/set of skills of the student. Typically, each portable device, at any particular time, may store a particular training module that is part of the student's customized educational program. The main training unit 16 may also include one or more different training modules (and one or more different version of each training module customized for different factors, such as a customized version with a larger percentage of African American male characters, a version with increased female characters, a version with more Hispanic male characters, a version with a baseball theme, etc.) and, based on the customized educational program of each individual student, downloads a particular training module (at the appropriate time) to each portable device. Note that each training module could also be constructed using a modular architecture so that, in a single version of a training module, different characters, content, themes, vocabulary, or other customized variables could be automatically swapped in, thereby permitting educational mass customization without creating multiple copies of the same or similar training modules.

In operation, each student receives individualized training and instruction (and can work at his/her own pace) since the system automatically adapts the training/instructions to each student using the educational customization factors. For example, when a student completes a training module, a portion of a training module (such as a particular assigned set of instructions or tasks) or after a predetermined time, such as if the assigned training is a nightly assignment or the assignment is a timed task, the portable device may upload (or the main training unit can pull data) the training/assignment results for the student to the main training unit over the network 14 so that the next set of instructions, assignment or training module may be delivered to the portable device for the student. For example, the portable device may upload the results from the assignment(s) completed by the student at home and then determine the next appropriate training/instructions to be completed by the student while at school so that the appropriate training/instruction to be completed at school (based on the training at home) can be delivered to the student. As another example, the student may complete a training/set of instructions in school and the results are uploaded to the main training unit to determine the next set of instructions/assignment to be delivered to the student while at school. As yet another example, the student may complete certain tasks/assignments during school and those results are uploaded to the main training unit so that the next training/assignment for the student is delivered to the student so that the student can work on that next training/assignment after school. Thus, the system receives the results from a student assignment (whether at home, away from school or at school) and then determines the next appropriate assignment (which may or may not be part of the training module already delivered to the student) that is delivered to the student so that the training/assignments delivery to each student is customized to the particular student.

In accordance with the invention, the results of the student may be forwarded to the appropriate teacher who may determine a next training/assignment. Alternatively, the main training unit may also automatically determine the appropriate next training/assignment to deliver to each portable device based on the results of each student. Thus, each student receives individualized training (and can work at his/her own pace) since the system automatically adapts the selection of training modules for each student. Furthermore, each assignment delivered to each portable device may implement known adaptive training techniques in which the difficulty of the training/assignment provided to each student is automatically adjusted based on the skill level of the student. Finally, the assignments delivered to each student (which may be part of a new training module or part of the training module already delivered to the student) are customized based on the educational customization factors so that the training module instruction is more engaging to the particular student.

FIG. 2 is a diagram illustrating an example of the portable device 12 shown in FIG. 1. The portable device may further include a power supply (not shown) such as a battery, rechargeable battery, etc. Each portable device also has sufficient display resources to permit the training module to display video and animations to the student in order to train the student's skills. Thus, the portable device may include a display unit 19, such as a liquid crystal display. The portable device 12 may further include a processing unit 20, such as a CPU, a communications interface 22, such as a wireless communications interface unit in a preferred embodiment, a persistent storage unit 24 such as flash memory, a hard disk drive or an optical drive, and a memory unit 26, such as SRAM or DRAM, that are coupled to each other. The persistent storage unit 24 may store code and does not lose its contents when power is removed from the portable device while the memory 26 temporarily stores the code currently being executed by the processing unit 20 as the memory 26 loses its contents when power is removed from the portable device. For example, when the portable device is being used to provide training to the user, the memory 26 may store an operating system 28 (which may also be executed from the persistent storage device) and a training module 30 that may be a piece of software having a plurality of lines of computer code executed by the processing unit 20 to implement the training contained in the training module. The portable device may further comprise one or more input devices 32, such as a keyboard, touchscreen, mouse, etc., that permits the student to interact with the portable device.

In accordance with the invention, the portable device may be a closed system in that it is locked, either with respect to its programming or with respect to the physical unit itself (e.g., no physical input slots, no drives, no ports, etc.) or both, so that only training modules/assignments may be delivered to and executed by the portable device. The system may download the new training module to each portable device, but may also erase the completed training module to limit the ability of the student to work in non-prescribed areas, to limit the ability to share the module to another user and/or to prevent software piracy. Alternatively, the portable device may be configured to permit the student to input/download other software, such as a game as a reward for a completed training module.

In operation, when a training module is resident in the portable device, the processing unit may execute the lines of code that make up the training module and display the training user interface to the student. The student, using the input devices, can interact with the training and respond to questions. The results of those questions are stored in the portable device and then later uploaded to the main training unit to assess the student's score for the particular training module.

FIG. 3 is a diagram illustrating an example of the main training unit 16 shown in FIG. 1. In the preferred embodiment, the main training unit may be a server computer. The data store 18, that may be a database, may store various information and data associated with the training system, such as the one or more training modules 40 described above and results 42 of the training. The results are stored in separate files/tables based on the particular student. However, the main training unit is also able to combine the results across multiple students/a class of students, etc. so that the results across one or more students may be analyzed and reviewed. The data store 18 may also store other information about each student such as each student's customized educational plan, the educational customization factors for each student, the reports for the student and the like.

The main training unit 16 may include a processing unit 44, such as one or more CPUs/processors, a communications interface 46, such as a wireless communications interface unit in a preferred embodiment, a persistent storage unit 48 as described above and a memory unit 50, such as SRAM or DRAM, that are connected together. When the main training unit is being used to implement the on-task learning system in accordance with the invention, the memory 50 may store an operating system 52, an adaptive software module 54 and a manager module 56 that are being executed by the processing unit 44. The adaptive software module interfaces with each portable device to deliver the appropriate training/assignment to each portable device while the manager module 56 performs the functions of 1) analyzing the results of the training for each student; 2) determining the appropriate training/assignment to deliver to each portable device based on each student's customized educational program which is known as educational mass customization (wherein the system may automatically generate the educational plan for each student using an assessment test when the student first starts using the system); 3) adjust the level of the training/assignment for each student; 4) forward the training results to the appropriate teachers/administrators in the school or to other appropriate parties (e.g., parents and guardians); and 5) generate reports of the training results. The system permits the training to be adjusted (including, but not limited to the time of the training (the pace of the training), the number of assignments for the training and/or the selection of assignment to train a particular skill or set of skills) to each student. As an example of the appropriate training to be delivered to the student, a training may include an assignment for six days wherein the student is to complete an assignment each day. One student might be able to complete the first assignment on the first day, the second and third assignments on the second day (by training on the portable device at home), the fourth and fifth assignments on the third day and the sixth assignment on the fourth day to complete the training. Another student might need more time to complete the training and may only complete the first 4 assignments over the six day period and may continue the training until all six assignments are completed. Another example is that a student might score sufficiently high on three of the six assignments that the system determines that the student can skip the remaining three assignments. Another example is that a student might score well on the first, second and fourth assignments, but poorly on the third assignment so that the system determines that the student can skip the fifth assignment, but now also needs to do a seventh assignment which trains the skills or set of skills from the third assignment in which the student performed poorly or trains one or more additional skills that the system has determined that the student should complete to improve the student's performance on the third assignment. Thus, each student is on task and the training is adjusted and customized for each student.

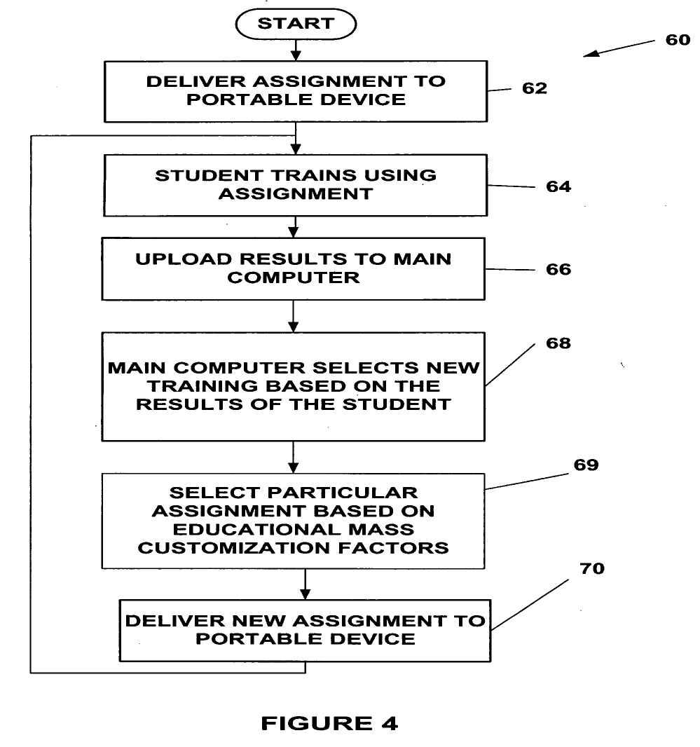

FIG. 4 is a flowchart illustrating a method 60 for educational training in accordance with the invention. In particular, the training method in accordance with the invention for a particular portable device is shown. In step 62, an assignment (which may be in a new training module or an existing training module already present on the portable device) is delivered to the portable device from the main training unit (or is already present on the portable device) based on the student's customized educational plan and the educational customization factors. In step 64, the student executes the assignment on the portable device and completes the training/assignment that has been adjusted to the student. As described above, the execution of the assignment may occur at any location (at home, at school or at any location.) In step 66, once the assignment has been completed (or at a predetermined interval for a timed assignment), the results for the student on the particular assignment are uploaded to the main training unit from the portable device. In accordance with the invention, the uploading of the results (as well as the delivery of the new assignments) may occur over a wireless network or using any other synchronization processes. In steps 68 and 69, the main training unit, using the results uploaded from the portable device, may determine the appropriate next training/assignment for the student based on the results of the prior assignment/training and the activated factors of the student as described above and the customized educational plan of the student. In accordance with the invention, it is possible that the main training unit may determine that the student should repeat the prior training due to the student results. In step 70, the main training unit delivers the new assignment/training (which might to be previous assignment), that might be part of a new training module or part of the training module already present on the portable device, to the portable device and the method loops back to step 64.

In accordance with the invention, the main training unit (the software-implemented manager application 56 in a preferred embodiment) may determine how to maximize the student's time-on-task and provide the customized educational plan for the student. As above, the main training unit may observe what the student's results from the prior module (and other activated factors of the student as described above) and make an informed determination as to which module to download next to continue the customized educational program for the student. However, the main training unit may do more than just select a new module to download. In particular, in order to maximize the time-on-task, the main training unit may both determine the module to download next for the student (i.e., what is the next appropriate task), but also how much of the module and how many different modules to download at that time as well, thereby also determining the appropriate amount of time to be spent on the tasks. Thus, the main training unit is automatically prescribing the time-on-task, not just tasks. In addition, the main training unit (and the manager application) may also provide the proper amount (i.e., volume of work) of modules to the student given the various activated factors of the student. In the alternative, the main training unit may “time” the modules so that a student will work for a predetermined period of time, such as 1 hour, and the main training unit will provide the student with as much work as the student can do in the allotted time. Thus, the customized educational program in accordance with the invention for a student (and in particular the homework for a particular night) may be volume, time delineated or both (e.g., the student does a particular volume of homework, but is limited to a particular period of time).

Furthermore, this determination about what tasks to download next may be determined not only based on the student's score (as described above), but also based on what particular areas of the overall scores were stronger or other patterns in the data that the manager module might recognize. Thus, once the system has evaluated all these different type of data and factors, it will download the appropriate module(s), according to its judgment of appropriate type, quantity and order of presentation. Thus, the main training unit (in this configuration) is able to make automated, individualized decisions about the appropriate updating and synchronizing that it will perform with respect to programs/modules, data and other aspects of each student's portable device.

This process described above, including those for providing (i) the intelligent and automated synchronization between the various portable and non-portable devices and servers, (ii) the automated synchronization and coordination of the activities of the students performed off-site as well as on-site, (iii) the automated synchronization and evaluation of the rich, diverse, highly individualized and continually changing detailed student information (generated, for example, by the educational mass customization program and/or the raw data and variables related to student performance), (iv) the automated and intelligent determination of what modules, programs, and/or work is appropriate for each individual student based on all the available criterion (whether for that night's homework or for larger assignments), (v) the automated and intelligent removal of work that is no longer appropriate, (vi) the automated, intelligent reporting, for example on individualized homework assignments created for each student versus how much of that unique assignment was actually completed, or of other measures of identified performance goals or objectives, (vii), the intelligent, automated process of periodic and ongoing assessments, the results of which are automatically incorporated into the module delivery algorithms, (viii) the ability to adjust the educational customization factors for a student based on the results of the student (such as adjusting the training schedule to use Monday as a review day only for a student whose results indicate that Monday is a bad day for learning) and the other functions described herein, each and in various combinations comprise the essence of the automated synchronization platform of the on-task learning system.

In accordance with another implementation of the autonomous synchronization platform, the system may permit students to play a learning game with each other on the portable devices, or at school, in a peer-to-peer manner. The system may query who else is playing/available for playing that is roughly at this same student's academic/ability level. Those other available students could be in the student's class, anywhere in that student's grade level, anywhere in that student's school in any grade level, anywhere in that student's district, anywhere in the United States, etc. (the scope of how broadly the system may locate other student's peer-to-peer partners is a variable to be set by the instructor/administrator of the particular system). The system may then intelligently link one or more than one additional player(s) who are identified by the system as being “appropriate play partners” to the first player so they all could play within a comparable zone. The definition of an “appropriate play partner” is also a variable to be set, either by academic levels, age levels, etc, or combinations of various characteristics. The system may also have a central database for tracking students who were reported for having “not played nicely” so that they can be blocked from being brought in to future peer-to-peer games. Furthermore, important data from the peer-to-peer play activities will also be tracked, e.g., under what combinations/scenarios are students learning faster or slower? or are some pairings more effective than others from an instructional perspective? This information would be fed back into the educational mass customization technology to further enhance that system. Thus, the system may enable the peer-to-peer playing of the training modules (which may be games in one embodiment.)

The autonomous synchronization platform may also provide additional, varied data reporting. The system may track and report to teachers various data like how a student scored on each training module and in overall skill areas, how long he played, etc, at home on the portable device or at school. The information can also be shared with that student's parents or guardians or other appropriate persons. The information about each student may be shared by various means, including being directly and automatically emailed to the parents. Further, at the end of the session, when the computer system determines the next tasks and times for the tasks, this information can also be reported to parents. Thus, parents, teachers and the student are always clear on what the expected/future homework is for tonight, or for this week, etc. so that the student's time-on-task is maximized. When reporting what homework was actually done and how the student did, it can be presented together with what the homework expectation/assignment was, how the actual homework compared to the work actually done by the student and the next homework assignment. This system is by its nature providing ongoing student assessment; it could also automatically trigger and/or provide periodic assessments based on a student's level of progress.

In accordance with the invention, the modules and training provided by the system mentioned above may have different time intervals or have different deadlines. For example, the assignments might be nightly or weekly, or at higher levels like high school or college, assignments/homework could be monthly assignments, with some things updating daily, and other modules/assignments updating monthly.

While the foregoing has been with reference to a particular embodiment of the invention, it will be appreciated by those skilled in the art that changes in this embodiment may be made without departing from the principles and spirit of the invention, the scope of which is defined by the appended claims.

1. An on-task learning system, comprising:
one or more portable devices;
a main training unit that communicates with the portable devices over a communications path;
the main training unit further comprising a manager unit having a selection unit that, based on educational information about a particular student, selects an assignment for the particular student, the assignment training a particular skill of the student, and an adaptive unit that interacts with the portable device to communicate the selected assignment to the portable device associated with the particular student;
the portable device associated with the particular student further comprising a processor that executes the selected assignment and uploads a set of results based on the selected assignment to the main training unit; and
wherein the educational information about the particular student is synchronized between the main training unit and the portable device associated with the particular student.

2. The system of claim 1, wherein the selection unit selects an assignment based on a set of educational customization factors associated with the particular student.

3. The system of claim 2, wherein the set of educational customization factors further comprises one or more pieces of information about one or more of a score of the particular student on prior assignments, a time interval it took the student to complete a particular portion of the educational program, an age of the student, a native language of the student, a race of the student, a gender of the student, a geographic location of the student, a hobby of the student and an interest of the student.

4. The system of claim 1, wherein the manager unit further comprises a unit that determines, once the selected assignment is completed by the particular student, a next assignment to be delivered to the portable device associated with the particular student.

5. The system of claim 4, wherein the next assignment is a training module that is downloaded to the portable device.

6. The system of claim 1, wherein each assignment incorporates adaptive training.

7. The system of claim 1, wherein the processor of the portable device deletes the selected assignment from the portable device when the student has completed the selected assignment.

8. The system of claim 1, wherein the main training unit is a computer system and preferably a server computer.

9. The system of claim 8, wherein each portable device further comprises one of a laptop computer, tablet computer, a handheld computer, pocket PC, PDA, wireless email device, and a mobile phone.

10. The system of claim 9, wherein each portable device is associated with a particular student.

11. The system of claim 9, wherein the communications path further comprises one of a wireless network, a cellular network, a wired computer network including a local area network or a wide area network, and a wireless computer network.

12. The system of 8 further comprising a data storage unit associated with the server computer, the data storage unit storing the assignments and the educational information about the particular student.

13. A computer-implemented on-task learning method that uses a central training unit and one or more portable devices that connect to the central training unit over a communications path to exchange educational information and assignments for a particular student, the method comprising:
selecting, at the central training unit, based on a set of educational information about a particular student, a assignment for the particular student that trains a particular skill of the student;
delivering the selected assignment to a portable device associated with the particular student;
training the particular student using the assignment on the portable device; and
uploading, from the portable device to the central training unit, a set of results based on the selected assignment wherein the educational information about the particular student is synchronized between the main training unit and the portable device associated with the particular student.

14. The method of claim 13, wherein selecting the assignment further comprises selecting the assignment based on a set of educational customization factors associated with the particular student.

15. The method of claim 14, wherein the set of educational customization factors further comprises one or more pieces of information about one or more of a score of the particular student on prior assignments, a time interval it took the student to complete a particular portion of the educational program, an age of the student, a native language of the student, a race of the student, a gender of the student, a geographic location of the student, a hobby of the student and an interest of the student.

16. The method of claim 13 further comprising determining, at the central training unit once the selected assignment is completed by the particular student and the set of results are uploaded to the central training unit, a next assignment to be delivered to the portable device associated with the particular student.

17. The method of claim 13, wherein training the student further comprises adaptively training the student.

18. The method of claim 13 further comprising, once the selected assignment is completed by the particular student, deleting the selected assignment from the portable device.

19. The method of claim 13 further comprising associating a particular student with a particular portable device.

20. The method of claim 13 further comprising storing, in a data storage unit associated with the central training unit, the assignments and the educational information about the particular student.

21. A central training unit of an on-task learning system that interacts with one or more portable devices, used by students, to train the students, the central training unit comprising:
a manager unit having a selection unit that, based on educational information about a particular student, selects an assignment for the particular student wherein the assignment trains a particular skill of the student;
an adaptive unit that is capable of interacting with a portable device to communicate the selected assignment to the portable device associated with the particular student; and
the manager unit further comprising a results unit that receives a set of results from the portable device when the selected assignment is completed wherein the educational information about the particular student is synchronized between the main training unit and the portable device associated with the particular student.

22. The unit of claim 21, wherein the selection unit selects the assignment based on a set of educational customization factors associated with the particular student.

23. The unit of claim 22, wherein the set of educational customization factors further comprises one or more pieces of information about one or more of a score of the particular student on prior assignments, a time interval it took the student to complete a particular portion of the educational program, an age of the student, a native language of the student, a race of the student, a gender of the student, a geographic location of the student, a hobby of the student and an interest of the student.

24. The unit of claim 21, wherein the manager unit further comprises a unit that determines, once the selected assignment is completed by the particular student, a next training module to be delivered to the portable device associated with the particular student.

25. The unit of claim 21, wherein each training module incorporates adaptive training.

26. The unit of claim 21, wherein the unit is a computer system and preferably a server computer.

27. The unit of 26 further comprising a data storage unit associated with the server computer, the data storage unit storing the training module and the educational information about the particular student.

28. A main training unit that provides educational mass customization to a student, the main training unit comprising:
a program having a plurality of assignments wherein each assignment trains one or more skills of a student;
a manager unit having:
an educational mass customization unit that determines a set of educational customization factors to associate with a particular student, the educational customization factors comprising one or more pieces of information about one or more of a score of the particular student on prior assignments, a time interval it took the student to complete a particular portion of the educational program, an age of the student, a native language of the student, a race of the student, a gender of the student, a geographic location of the student, a hobby of the student, an interest of the student, a game preference, a learning preference and an adaptive evolution of a character in the assignment; and
a selection unit that, based on a set of educational customization factors associated with a particular student, selects an assignment for the particular student to be delivered to the particular student wherein the selected assignment maintains a time on task of the particular student by engaging the particular student due to the educational customization factors.

29. The unit of claim 28, wherein the plurality of assignments further comprises a set of assignments that contain the same training wherein the set of assignments further comprises a first assignment having a first theme that engages a student having a first set of educational customization factors and a second assignment having a second theme that engages a student having a second set of educational customization factors.

30. The unit of claim 28, wherein the educational mass customization unit further comprises a unit that receives a set of results for the selected assignment of the particular student and wherein a next assignment for the particular student is chosen based on the set of results.

31. The unit of claim 28, wherein the educational mass customization unit further comprises a unit that determines, once the selected assignment is completed by the particular student, a next assignment for the particular student.

32. The unit of claim 28, wherein each assignment incorporates adaptive training.

33. An educational mass customization method that uses a main training unit to communicate an assignment to a particular student wherein the main training unit has a database with a plurality of assignments wherein each assignment trains a particular skill of a student, the method comprising:
determining, using an educational mass customization unit, a set of educational customization factors to associate with a particular student, the educational customization factors comprising one or more pieces of information about one or more of a score of the particular student on prior assignments, a time interval it took the student to complete a particular portion of the educational program, an age of the student, a native language of the student, a race of the student, a gender of the student, a geographic location of the student, a hobby of the student, an interest of the student, a game preference, a learning preference and an adaptive evolution of a character in the assignment; and
selecting, using a selection unit, based on a set of educational customization factors associated with a particular student, an assignment for the particular student to be delivered to the particular student wherein the selected assignment maintains a time on task of the particular student by engaging the particular student due to the educational customization factors.

34. The method of claim 33, wherein the plurality of assignments further comprises a set of assignments contain the same training wherein the set of assignments further comprises a first assignment having a first theme that engages a student having a first set of educational customization factors and a second assignment having a second theme that engages a student having a second set of educational customization factors.

35. The method of claim 33 further comprising receiving a set of results for the selected assignment of the particular student and selecting a next assignment for the particular student based on the set of results.

36. The method of claim 33 further comprising determining, once the selected assignment is completed by the particular student, a next assignment for the particular student.

37. The method of claim 33, wherein each assignment incorporates adaptive training.
